(19) United States
(12) Patent Application Publication
(10) Pub. No.: US 2026/0302469 A1
(43) Pub. Date: Oct. 1, 2026

(54) Battery Module

(71) Applicant: Nissan Motor Co., Ltd., Yokohama-shi, Kanagawa (JP)

(72) Inventors: Yozo Hirose, Kanagawa (JP); Taewon Kim, Kanagawa (JP); Koichiro Aotani, Kanagawa (JP); Yosuke Suzuki, Kanagawa (JP); Kimio Nishimura, Kanagawa (JP); Norihiko Hirata, Kanagawa (JP); Hideki Watanabe, Kanagawa (JP)

(21) Appl. No.: 19/477,368

(22) PCT Filed: Apr. 28, 2023
(86) PCT No.: PCT/JP2023/016951

§ 371 Date: Oct. 21, 2025

(51) Int. Cl. H01M 50/242; H01M 10/04; H01M 50/204

(52) U.S. Cl. CPC H01M 50/242; H01M 10/0468; H01M 50/204

(57) ABSTRACT

A battery module includes a battery stack constituted of battery cells stacked along a Z-direction, a pair of pressurizing bodies that sandwich two end surfaces of the battery stack in the Z-direction, and applies pressure on the battery stack along the Z-direction, an elastic body that connects the pair of pressurizing bodies, and pulls the pair of pressurizing bodies in a direction in which the pair of pressurizing bodies come close to one another, and a driving mechanism capable of moving the pressurizing body along the Z-direction.

### TECHNICAL FIELD

The present invention relates to a battery module.

### BACKGROUND

There has been known a restraining structure including a restraining band that restrains an outer periphery of a battery pack made by stacking a plurality of battery cells while applying pressure in a stacking direction of the battery cells, and a variable restraint device disposed at a seam end of the restraining band (see, for example, JP-A-2013-20891).

### SUMMARY

However, the prior art has a problem that a variable restraint device fails to withstand high applied pressure.

An object that the present invention attempts to achieve is to provide a battery module having high durability against applied pressure on a battery stack.

The present invention achieves the above-described object by disposing a pair of pressurizing bodies that sandwich a battery stack constituted of a plurality of battery cells stacked along a first direction, an elastic body that connects the pair of pressurizing bodies, and pulls the pair of pressurizing bodies in a direction in which the pair of pressurizing bodies come close to one another, and a driving mechanism capable of moving at least one of the pressurizing bodies along the first direction.

The present invention allows for improving durability against applied pressure on a battery stack.

### BRIEF DESCRIPTION OF THE DRAWINGS

FIG. 1 is a perspective view of a battery module in an embodiment of the present invention;

FIG. 2 is a plan view of a driving mechanism in the embodiment of the present invention;

FIG. 3 is a side view viewed from the direction III in FIG. 2;

FIG. 4 is a cross-sectional view taken along the line IV-IV in FIG. 2, and a drawing on the left is a cross-sectional view illustrating a state before an occurrence of self-discharging of a battery cell and a drawing on the right is a cross-sectional view illustrating a state after the occurrence of the self-discharging of the battery cell;

FIG. 5 is an enlarged cross-sectional view of the portion V in FIG. 4;

FIG. 6 is a plan view of a driving mechanism of a modification;

FIG. 7 is a cross-sectional view of a fitting portion in the modification; and

FIG. 8 is a cross-sectional view of a second pressurizing body in the modification.

### DETAILED DESCRIPTION

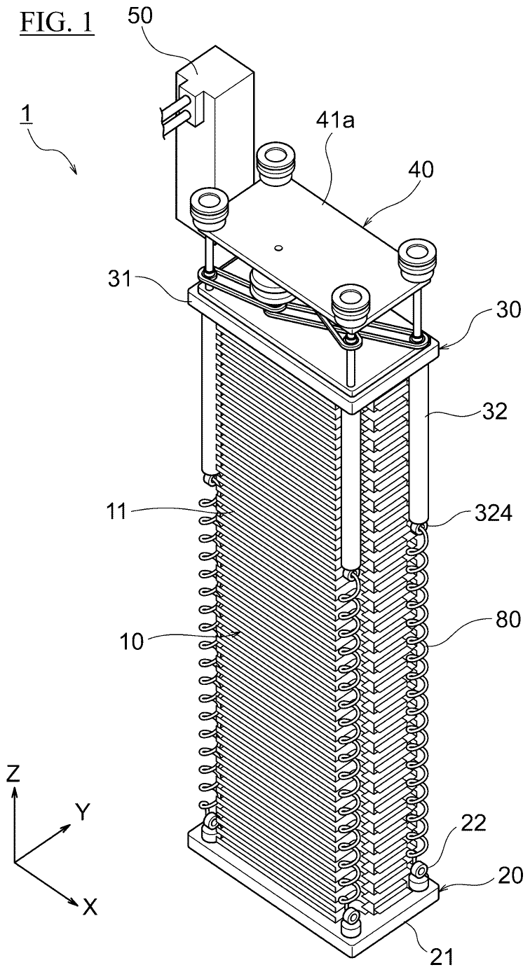

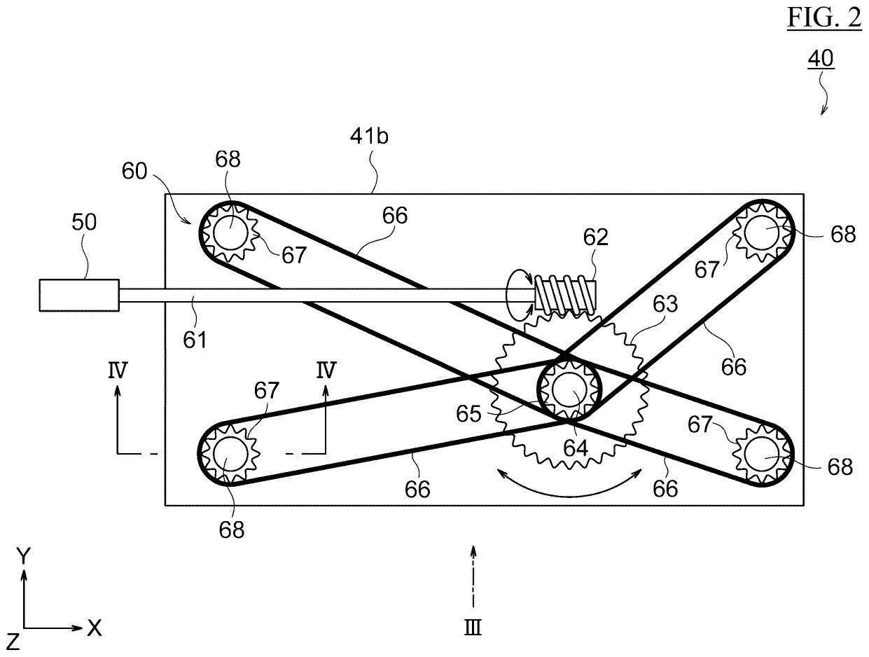

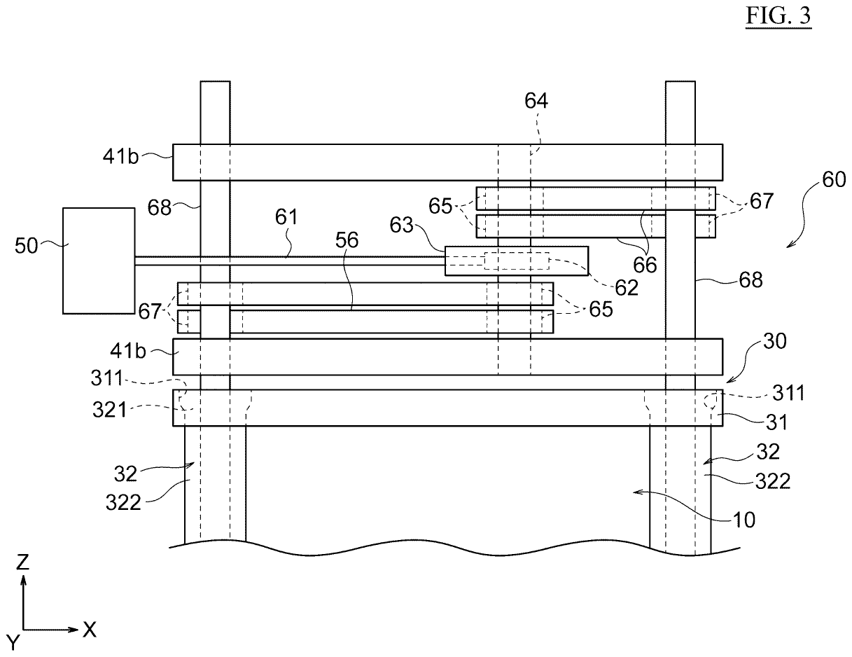

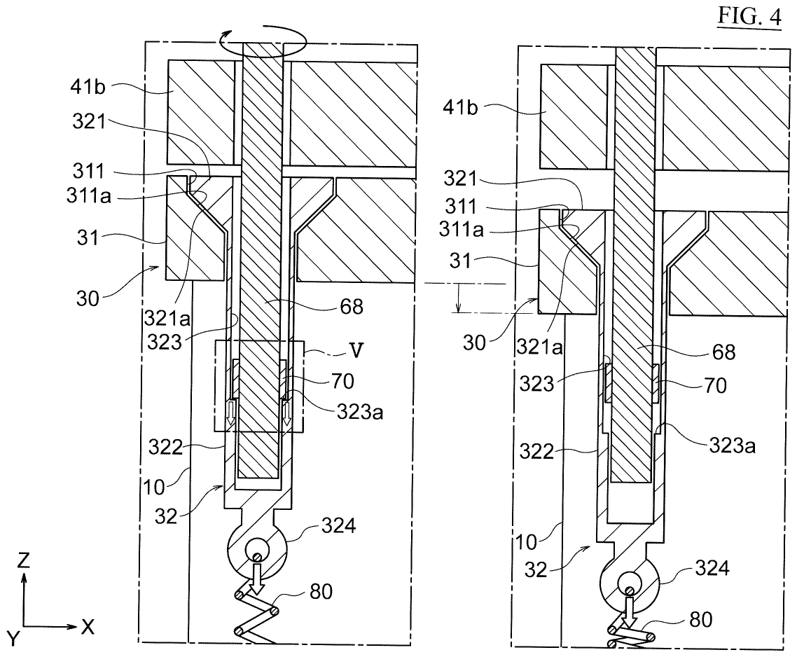

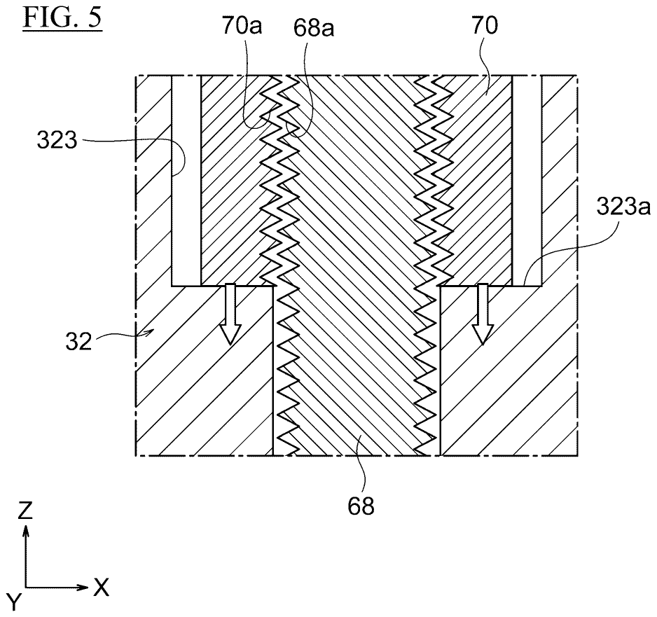

The following describes an embodiment of the present invention with reference to the drawings. FIG. 1 is a perspective view of a battery module according to the embodiment. FIG. 2 is a plan view of a driving mechanism according to the embodiment. FIG. 3 is a side view viewed from the direction III in FIG. 2. FIG. 4 is a cross-sectional view taken along the line IV-IV in FIG. 2, and a drawing on the left is a cross-sectional view illustrating a state before an occurrence of self-discharging of a battery cell and a drawing on the right is a cross-sectional view illustrating a state after the occurrence of the self-discharging of the battery cell. FIG. 5 is an enlarged cross-sectional view of the portion V in FIG. 4. Note that in the drawings, a battery module 1 is illustrated in a state of being placed vertically for ease of illustration and understanding, but the battery module 1 may be horizontally placed inside a battery pack mounted on a vehicle.

As illustrated in FIG. 1, the battery module 1 according to the embodiment includes a battery stack 10, a first pressurizing body 20, a second pressurizing body 30, a driving mechanism 40, and an elastic body 80.

The battery stack 10 according to the embodiment is constituted of a plurality of battery cells 11. The plurality of battery cells 11 according to the embodiment are not specifically limited, but are all-solid batteries. Note that the battery cell 11 may be a lithium ion secondary battery containing an electrolyte.

The plurality of battery cells 11 according to the embodiment are mutually stacked along a Z-direction in the drawing. Electrode tabs of the battery cells 11 adjacent to one another are electrically connected, thereby electrically connecting the plurality of battery cells 11 as well. The electrode tabs may be bonded by welding or the like or may be electrically connected via busbars. The Z-direction according to the embodiment corresponds to one example of a “first direction” according to the present invention.

This battery stack 10 has two end surfaces in the Z-direction that are sandwiched by a pair of pressurizing bodies 20, 30, and the pair of pressurizing bodies 20, 30 applies pressure on the battery stack 10 along the Z-direction.

The first pressurizing body 20 abuts on the battery stack 10 from a −Z-direction side. Although not particularly illustrated, the first pressurizing body 20 according to the embodiment is secured inside the battery pack. Note that the first pressurizing body 20 may be movable along the first direction similarly to the second pressurizing body 30 described below.

This first pressurizing body 20 includes a plate-shaped main body portion 21 and a plurality (four in this example) of spring securing portions 22. The plate-shaped main body portion 21 is a plate-shaped member having rigidity, and although it is not specifically limited, is constituted of a metal, such as aluminum or stainless steel. This plate-shaped main body portion 21 abuts on the end surface of the battery stack 10 in the −Z-direction.

The spring securing portion 22 is disposed in a peripheral area of the battery stack 10 on the plate-shaped main body portion 21. The spring securing portion 22 is a portion that secures one end of the elastic body 80. Although not specifically limited, the spring securing portion 22 according to the embodiment has a tubular shape, and the one end of the elastic body 80 is secured internally thereto.

As illustrated in FIG. 1 and FIG. 3, the second pressurizing body 30 abuts on the battery stack 10 from a +Z-direction side. The second pressurizing body 30 according to the embodiment is movable along the Z-direction.

This second pressurizing body 30 includes a plate-shaped main body portion 31 and a plurality (four in this example) of tubular portions 32. The plate-shaped main body portion 31 is a plate-shaped member having rigidity, and although it is not specifically limited, is constituted of a metal, such as aluminum or stainless steel. This plate-shaped main body portion 31 abuts on the end surface of the battery stack 10 in the +Z-direction.

As illustrated in the drawing on the left in FIG. 4, the plate-shaped main body portion 31 has a plurality (four in this example) of fitting holes 311. This fitting hole 311 is a through-hole that passes through the plate-shaped main body portion 31, and a fitting portion 321 of the tubular portion 32 is fitted in the fitting hole 311.

The tubular portion 32 is inserted through the fitting hole 311. The tubular portion 32 is disposed in a peripheral area of the battery stack 10. This tubular portion 32 may be constituted of a metal or the like, similarly to the plate-shaped main body portion 31. The tubular portion 32 according to the embodiment is a separate body and is not formed integrally with the plate-shaped main body portion 31.

The tubular portion 32 includes the fitting portion 321, an extending portion 322, a closed-end hole 323, and a spring securing portion 324. The fitting portion 321 is disposed at an upper end of the tubular portion 32, and is fitted in the fitting hole 311 of the plate-shaped main body portion 31. The fitting portion 321 according to the embodiment includes a fitting surface 321a in a taper shape. The fitting surface 321a is a surface that comes in contact with an inner wall of the fitting hole 311, and a contact surface 311a of this inner wall in contact with the fitting surface 321a includes a surface shape corresponding to the fitting surface 321a.

The extending portion 322 extends from this fitting portion 321 along the −Z-direction. The extending portion 322 is a portion that houses a feed screw 68 and a contact body 70 described later, and is a portion pressed toward the −Z-direction by the contact body 70.

The closed-end hole 323 is formed in the fitting portion 321 and the extending portion 322. This closed-end hole 323 is opened in the fitting portion 321, and on the other hand, is obstructed at a distal end of the extending portion 322.

The spring securing portion 324 is disposed at the distal end of the extending portion 322. This spring securing portion 324 is a portion that secures the other end of the elastic body 80. Although not specifically limited, the spring securing portion 324 according to the embodiment has a tubular shape with a through-hole along a Y-direction, and the other end of the elastic body 80 is internally secured thereto.

The driving mechanism 40 illustrated in FIG. 1 is electronically controlled, and is capable of moving the second pressurizing body 30 along the Z-direction. More specifically, this driving mechanism 40 is electronically controlled by a control system, such as an ECU, mounted on a vehicle. This allows for the driving mechanism 40 to control the applied pressure on the battery stack 10 by the first and the second pressurizing bodies 20, 30. The driving mechanism 40 according to the embodiment is capable of moving the second pressurizing body 30 along the Z-direction corresponding to a change in thickness of the battery stack 10 due to charging and discharging when the battery cell 11 is used.

As illustrated in FIG. 1, FIG. 2, and FIG. 4, the driving mechanism 40 according to the embodiment includes a pair of support plates 41a, 41b, a motor 50, a transmission mechanism 60, and the contact body 70 (see FIG. 4). The pair of support plates 41a, 41b are a part of a gearbox, and support the transmission mechanism 60.

As illustrated in FIG. 2 and FIG. 3, the motor 50 is a driving source, and transmits power to the contact body 70 (see FIG. 4) via the transmission mechanism 60. Although not specifically limited, a stepping motor is allowed to be used for this motor 50. Alternatively, a servo motor may be used for the motor 50. However, the kind of the motor 50 is not limited to those as described above.

The transmission mechanism 60 transmits the power of the motor 50 to the contact body 70 (see FIG. 4). This transmission mechanism 60 includes a shaft 61, a worm (screw gear) 62, a worm wheel 63, a rotating shaft 64, a plurality (four in this example) of first sprockets 65, a plurality (four in this example) of chains 66, a plurality (four in this example) of second sprockets 67, and a plurality (four in this example) of the feed screws 68.

The shaft 61 is axially rotatable by power of the motor 50. The worm 62 is disposed at a distal end of this shaft 61. The worm 62 has a cylindrical shape, and has a screw shaped (a spiral shaped) teeth on its outer periphery. This worm 62 is rotatable in association with the rotation of the shaft 61. This worm 62 engages with the worm wheel 63. The worm wheel 63 is a spur gear rotatable about the rotating shaft 64. The worm 62 and the worm wheel 63 as described above constitute a worm gear. In the worm gear according to the embodiment, the worm 62 is disposed on a side of the motor 50, and the worm wheel 63 is disposed on a side of the contact body 70 (see FIG. 4).

In the worm gear according to the embodiment, the power from the motor 50 allows the worm wheel 63 to rotate via the worm 62. Meanwhile, even though force is applied on the worm wheel 63 along the rotation direction, the worm 62 fails to be rotated due to friction force between the worm wheel 63 and the worm 62.

The four first sprockets 65 are secured to the rotating shaft 64. These first sprockets 65 are rotatable in association with the rotation of the rotating shaft 64. Each of the first sprockets 65 engages with the chain 66. Each of the chains 66 engages with the second sprocket 67 secured to the feed screw 68, and is allowed to rotate the feed screw 68 by transmitting the rotation of the first sprocket 65 to the second sprocket 67. As illustrated in FIG. 3, the feed screw 68 passes through the support plate 41b, and extends to the inside of the tubular portion 32 of the pressurizing body 30. As illustrated in FIG. 5, this feed screw 68 has a thread groove 68a in a spiral shape on an outer peripheral surface.

As illustrated in the drawing on the left in FIG. 4, the contact body 70 is disposed on the feed screw 68. The contact body 70 is movable along the Z-direction by the power from the motor 50. As illustrated in FIG. 5, this contact body 70 has a pipe shape and includes a thread groove 70a in a spiral shape that screws with the thread groove 68a on an inner peripheral surface thereof. Note that, while in FIG. 5, the thread groove 68a and the thread groove 70a are slightly separated for ease of illustration and understanding, they are at least partly screwed in practice. Therefore, the contact body 70 is moveable along the first direction in accordance with the rotation of the feed screw 68.

As illustrated in the drawing on the left in FIG. 4 and FIG. 5, this contact body 70 can be in contact with a lock surface 323a formed in the closed-end hole 323. Note that the lock surface 323a is a planar surface that extends in a direction (an XY-direction) perpendicular to an extending direction (the Z-direction) of the extending portion 322. Accordingly, the contact body 70 presses this lock surface 323a, thereby successfully pressing the second pressurizing body 30 toward the −Z-direction. This allows for the plate-shaped main body portion 31 of the pressurizing body 30 to apply pressure on the battery stack 10.

In the driving mechanism 40 having the configuration as described above, the motor 50 is electronically controlled, and thus, the second pressurizing body 30 is moved in the first direction, thereby allowing for controlling a magnitude of pressure applied on the battery stack 10 by the second pressurizing body 30. More specifically, the second pressurizing body 30 is controlled so as to follow the change in thickness of the battery stack 10 due to charging and discharging of the battery cell 11, and thus, the pressure applied from the second pressurizing body 30 onto the battery stack 10 can be adjusted within an appropriate range.

As illustrated in FIG. 1, the elastic body 80 is disposed between the spring securing portion 22 and the spring securing portion 324, and connects the first pressurizing body 20 to the second pressurizing body 30. Although not specifically limited, a coil spring is allowed to be used for this elastic body 80. Alternatively, a rubber band or the like may be used for the elastic body 80.

This elastic body 80 pulls the first pressurizing body 20 and the second pressurizing body 30 in a direction in which the first pressurizing body 20 and the second pressurizing body 30 come close to one another. That is, the elastic body 80 according to the embodiment pulls the first pressurizing body 20 in the +Z-direction and pulls the second pressurizing body 30 in the −Z-direction. Thus, the second pressurizing body 30 applies pressure on the battery stack 10 by the tensile force applied from the elastic body 80 in addition to the pressing force applied from the contact body 70.

The battery module 1 as described above allows for the driving mechanism 40 and the elastic body 80 to apply force onto the second pressurizing body 30, which allows for dispersing the applied pressure between the driving mechanism 40 and the elastic body 80. Therefore, even when high pressure is applied on the battery stack 10, the driving mechanism 40 and the elastic body 80 can withstand the high pressure. In view of this, the durability of the battery module 1 is improved.

In particular, in this embodiment, the motor 50 is used as the driving source of the driving mechanism 40, and a screw mechanism decelerated by a gear is used as the transmission mechanism 60 and the contact body 70 that transmit the power of this motor 50. In view of this, even when an expansion amount and a shrinkage amount of the battery stack 10 are increased and a moving amount of the second pressurizing body 30 along the first direction is increased, the torque of the motor 50 and the pressure (the load) from the second pressurizing body 30 are easily controlled to be constant. That is, the battery module 1 according to the embodiment is excellent in controllability of the pressure applied on the battery stack 10. For example, when a link-type jack or the like is used for the driving mechanism, the pressure is easily changed corresponding to the angle of the link of the jack, but this embodiment is able to keep the pressure constant irrespective of the position of the second pressurizing body 30. Note that, examples of the case where the expansion amount and the shrinkage amount of the battery stack 10 are increased can include, for example, the case where an all-solid battery is used for the battery cell 11.

In this embodiment, in addition to the driving mechanism 40, the elastic body 80 can apply a force onto the second pressurizing body 30. Since the driving mechanism 40 is driven by electronical control, the driving requires an electric power, and the driving fails when the electric power is not supplied. For example, when the battery module 1 is mounted on a vehicle, and an ignition switch of the vehicle is turned off and a control system is also turned off, the driving mechanism 40 may fail to be driven. On the other hand, when the vehicle is left for a long time, the battery cell 11 self-discharges, which may reduce the thickness of the battery stack 10.

In this case, as illustrated in the drawing on the right in FIG. 4, the battery stack 10 shrinks, and the contact body 70 separates from the lock surface 323a. However, since the second pressurizing body 30 is pulled by the elastic body 80, the plate-shaped main body portion 31 of the second pressurizing body 30 follows the shrinking of the battery stack 10, and thus, the plate-shaped main body portion 31 can apply pressure on the battery stack 10 without separating from the battery stack 10. That is, the elastic body 80 brings the pressurizing bodies 20, 30 close to one another along the Z-direction corresponding to the reduction of the thickness of the battery stack 10 due to the self-discharging of the battery cell 11. Thus, the battery module 1 according to this embodiment is capable of following the reduction of the thickness of the battery stack 10 due to the self-discharging of the battery cell 11 even under the condition where the driving mechanism 40 fails to operate.

In this embodiment, the elastic body 80 applies pressure on all the battery cells 11 along the Z-direction via the first and the second pressurizing bodies 20, 30. This allows for downsizing of the battery module 1 compared with the case where the elastic bodies are interposed between the battery cells 11 to apply pressure on the battery cells individually with the elastic bodies.

In this embodiment, the driving mechanism 40 includes the plurality of contact bodies 70, which allows the second pressurizing body 30 to be moved along the Z-direction while maintaining the posture of the second pressurizing body 30 to be approximately parallel (approximately parallel to the XY surface in the drawing) with respect to the battery cell 11. Specifically, in this embodiment, since one worm gear transmits the power to all the feed screws 68, all the feed screws 68 can have the same rotation phase angles. This allows for uniformizing the pressure applied on the battery stack 10 on the end surface of the battery stack 10.

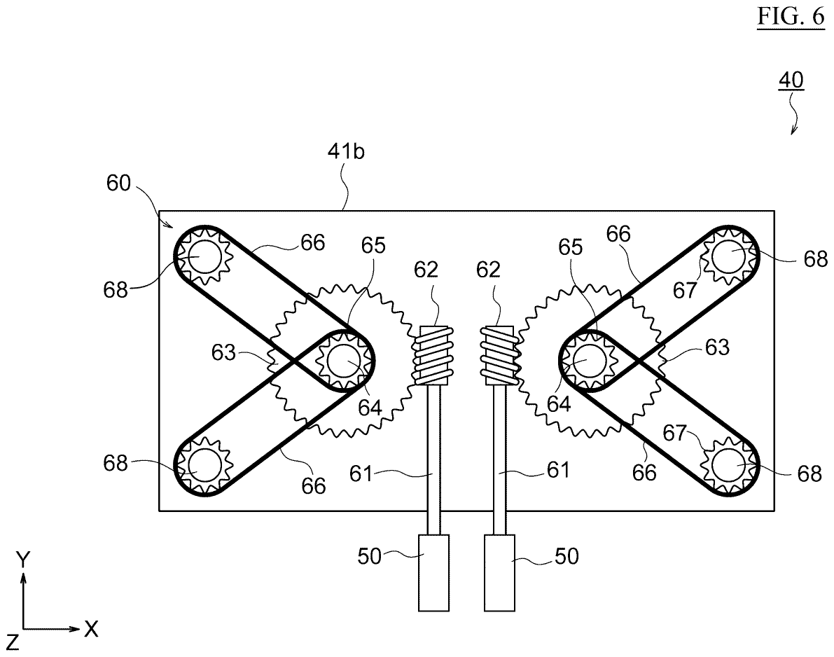

Note that, as illustrated in FIG. 6, in the transmission mechanism 60 having a plurality of pairs of the feed screws 68, the pair of the feed screws 68 may be respectively and independently controlled. FIG. 6 is a plan view of the driving mechanism 40 in a modification.

In this modification, two pairs of the feed screws 68 are independently controlled by the power from the separate motors 50. With such a modification, even in the case where, for example, the battery cells 11 do not expand uniformly, the second pressurizing body 30 can be moved along the Z-direction while maintaining the posture of the second pressurizing body 30 to be approximately parallel with respect to the battery cell 11. The case where the battery cells 11 do not expand uniformly is, for example, the case where a bulge in a central portion of the battery cell 11 is significant. In such a case, a main surface of the battery cell 11 has a convex curved surface.

In this embodiment, as illustrated in FIG. 4, the fitting surface 321a has a tapered shape. While the plate-shaped main body portion 31 of the second pressurizing body 30 may be deformed into a convex shape in association with the applied pressure, the fitting surface 321a has a tapered shape, and thus, the tubular portion 32 is less susceptible to the deformation of the plate-shaped main body portion 31. For example, when the fitting surface is a surface parallel in the Z-direction or a surface horizontal in the Z-direction, the tubular portion 32 is inclined in the +X-direction in association with the deformation of the plate-shaped main body portion 31, and the inner wall of the tubular portion 32 may interfere with the rod-shaped feed screw 68 or the contact body 70. When this interference occurs, a problem that the movement of the contact body 70 in the first direction is inhibited or the like may be caused. Meanwhile, in this embodiment, the tubular portion 32 is less susceptible to the deformation of the plate-shaped main body portion 31 because of the fitting surface 321a in the tapered shape, and therefore, the tubular portion 32 is difficult to be inclined, and the second pressurizing body 30 can stably apply pressure on the battery stack 10.

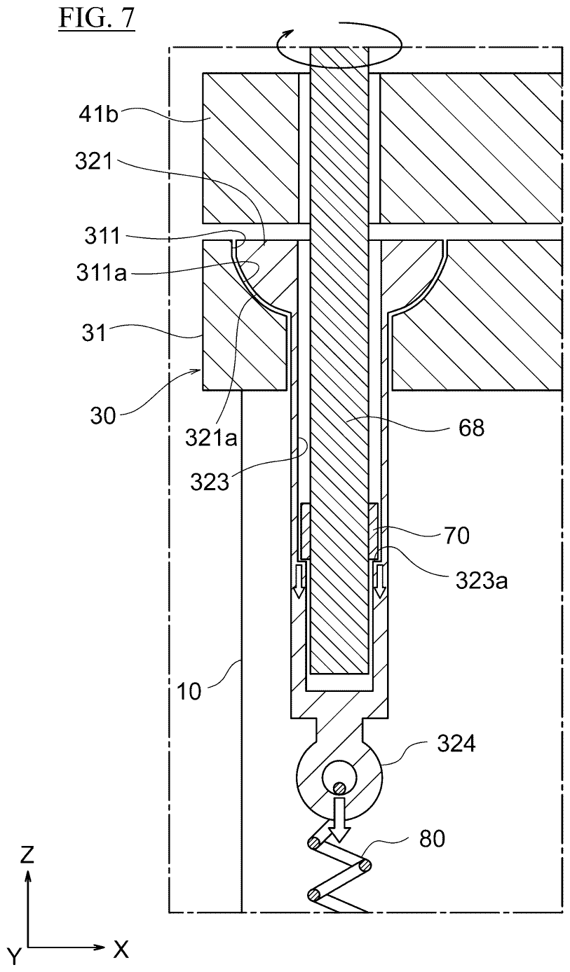

FIG. 7 is a cross-sectional view of the fitting portion 321 in the modification. In the above-described embodiment, the fitting surface 321a of the fitting portion 321 is in a taper-shaped, but the shape is not limited to this. For example, as illustrated in FIG. 7, the fitting surface 321a may be a curved-surface-shaped surface. Also in this case, the second pressurizing body 30 can stably apply pressure on the battery stack 10 similarly to the above.

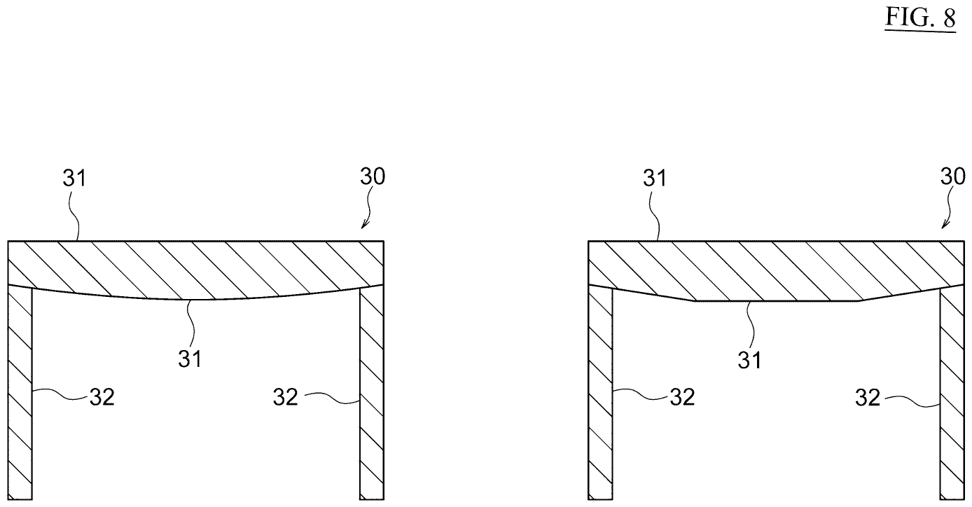

As illustrated in FIG. 3, in this embodiment, a contact surface 31a of the plate-shaped main body portion 31 with the battery stack 10 is in a planar shape, but the shape is not limited to this. The contact surface 31a may include a convex shape projecting toward the battery stack 10. FIG. 8 is a cross-sectional view of the second pressurizing body 30 in a modification.

As illustrated in the drawing on the left in FIG. 8, the cross-sectional surface of the plate-shaped main body portion 31 may have a non-spherical surface, and the contact surface 31a may have a curved surface. Alternatively, as illustrated in the drawing on the left in FIG. 8, the contact surface 31a may have a tapered shape. Thus, the contact surface 31a including a convex shape projecting toward the battery stack 10 allows for the contact surface 31a to appropriately press the end surface of the battery stack 10 even when the plate-shaped main body portion 31 is deformed to be curved by the load as described above, and therefore, a pressure can be uniformly applied on the end surface. Note that when the deformation of the plate-shaped main body portion 31 is reduced by constituting the plate-shaped main body portion 31 using a metal high in rigidity, such as SUS, the weight of the plate-shaped main body portion 31 increases. In contrast to this, in this embodiment, the deformation of the plate-shaped main body portion 31 is permitted to a certain degree, and the plate-shaped main body portion 31 is constituted of a material of a light weight, and thus, the weight of the battery module 1 can be reduced.

As illustrated in FIG. 2, in this embodiment, the transmission mechanism 60 includes the worm 62 disposed on the motor 50 side, and the worm gear including the worm wheel 63 disposed on the contact body 70 side. The worm wheel is not rotatable by the force from the contact body 70 side due to the friction force with the worm 62. This allows for maintaining the pressure on the battery stack 10 when the power of the vehicle is turned off even without adding a mechanism to lock the motor 50. For example, in a fluid pressure mechanism, such as a hydraulic pressure, it is necessary to add a device, such as a check valve and an accumulator, in order to maintain the pressure in a state where a hydraulic pressure pump is stopped, and it is difficult in principle as a mechanism to maintain the pressure without the power for a long period of time.

Note that in this embodiment, the first pressurizing body 20 does not move along the first direction, but it is not limited to this. The first pressurizing body 20 is not necessarily secured and may have a tubular portion, similarly to the second pressurizing body 30. In this case, similarly to the second pressurizing body 30, addition of the driving mechanism 40 and the contact body 70 enables the second pressurizing body 30 to move along the first direction.

### DESCRIPTION OF REFERENCE NUMERALS

1 battery module
10 battery stack
11 battery cell
20 first pressurizing body
21 plate-shaped main body portion
22 spring securing portion
30 second pressurizing body
31 plate-shaped main body portion
31a contact surface
311 fitting hole
311a contact surface
32 tubular portion
321 fitting portion
321a fitting surface
322 extending portion
323 closed-end hole
323a lock surface
324 spring securing portion
40 driving mechanism
41a, 41b support plate
50 motor
60 transmission mechanism
61 shaft
62 worm (screw gear)
63 worm wheel
64 rotating shaft
65 first sprocket
66 chain
67 second sprocket
68 feed screw
68a thread groove
70 contact body
71 inner peripheral surface
80 elastic body

1. A battery module comprising:
a battery stack constituted of battery cells stacked along a first direction;
a pair of pressurizing bodies that sandwich two end surfaces of the battery stack in the first direction, and applies a pressure on the battery stack along the first direction;
an elastic body that connects the pair of pressurizing bodies, and pulls the pair of pressurizing bodies in a direction in which the pair of pressurizing bodies come close to one another; and
a driving mechanism capable of moving at least one of the pressurizing bodies along the first direction.

2. The battery module according to claim 1, wherein the elastic body applies pressure on all the battery cells along the first direction via the pair of pressurizing bodies.

3. The battery module according to claim 2, wherein
the driving mechanism moves at least one of the pressurizing bodies along the first direction corresponding to a change in thickness of the battery stack due to charging and discharging when the battery cell is used, and
the elastic body brings the pair of pressurizing bodies close to one another along the first direction corresponding to reduction in the thickness of the battery stack due to self-discharging of the battery cell.

4. The battery module according to claim 1, wherein the driving mechanism includes:
a driving source; and
contact bodies that are disposed to be contactable on the pressurizing body, and are movable along the first direction by power from the driving source, and
the driving mechanism moves the pressurizing body along the first direction while maintaining a posture of the pressurizing body to be approximately parallel to the battery cell by the contact bodies.

5. The battery module according to claim 1, wherein the pressurizing body includes:
a plate-shaped main body portion having a fitting hole; and
a tubular portion that has a fitting portion that fits in the fitting hole, and extends from the plate-shaped main body portion along the first direction,
the driving mechanism includes:
a rod-shaped feed screw that is housed inside the tubular portion and has a thread groove on an outer peripheral surface; and
a contact body that has an inner peripheral surface that screws with the thread groove, moves along the first direction by rotation of the feed screw, and is capable of pressing the tubular portion, and
the fitting portion includes a taper-shaped or curved-surface-shaped surface that comes in contact with an inner wall of the fitting hole.

6. The battery module according to claim 1, wherein
the pressurizing body includes a plate-shaped main body portion having a contact surface that comes in contact with the battery stack, and
the contact surface includes a convex shape projecting toward the battery stack.

7. The battery module according to claim 1, wherein the driving mechanism includes:
a driving source;
a contact body that is disposed to be contactable on the pressurizing body, and is movable along the first direction by power from the driving source; and
a transmission mechanism that is interposed between the driving source and the contact body, and transmits the power from the driving source to the contact body,
the transmission mechanism includes a worm gear, the worm gear includes:
a worm disposed on a side of the driving body; and
a worm wheel that is disposed on a side of the contact body and engages with the worm, and
the worm wheel fails to rotate by force from the contact body side due to friction force with the worm.

8. The battery module according to claim 1, wherein the driving mechanism includes a motor as a driving source.

9. The battery module according to claim 8, wherein the pressurizing body includes:
a plate-shaped main body portion; and
a tubular portion extending from the plate-shaped main body portion along the battery stack,
the driving mechanism further includes:
a rod-shaped feed screw that is housed inside the tubular portion, is rotatable by power from the driving source, and has a thread groove on an outer peripheral surface; and
a contact body that has an inner peripheral surface that screws with the thread groove, moves along the first direction by rotation of the feed screw, and is capable of pressing the tubular portion, and
the elastic body is connected to the tubular portion.
